(19) United States
(12) Patent Application Publication
(10) Pub. No.: US 2025/0303504 A1
(43) Pub. Date: Oct. 2, 2025

(54) METHOD OF MAKING ALUMINUM BRAZING SHEET

(71) Applicants: HINDALCO INDUSTRIES LIMITED, Mumbai, Maharashtra (IN); INDIAN INSTITUTE OF TECHNOLOGY MADRAS, Chennai, Tamil Nadu (IN)

(72) Inventors: SUSHANTA KUMAR PANIGRAHI, Chennai, Tamil Nadu (IN); Vivek SRIVASTAVA, Navi Mumbai, Maharashtra (IN)

(21) Appl. No.: 18/706,909

(22) PCT Filed: Nov. 1, 2022
(86) PCT No.: PCT/IN2022/050961

§ 371 Date: May 2, 2024

(30) Foreign Application Priority Data
Nov. 2, 2021 (IN) 202121040156

(51) Int. Cl. B23K 35/02; B21B 3/00; B23K 35/28; B32B 15/01

(52) U.S. Cl. CPC B23K 35/0238; B21B 3/00; B23K 35/286; B32B 15/016; B21B 2003/001

(57) ABSTRACT

Provided herein is a method for making aluminium brazing sheets comprises of, a) providing a core of first aluminium alloy; b) cladding said core, on one or two sides, with a second aluminium alloy, forming a laminate structure; c) performing a primary cold rolling of said laminate structure so as to roll bond core and cladding 5 alloy of said laminate structure; and d) performing at least one secondary cold rolling step of roll bonded laminate structure to obtain aluminium brazing sheet of desired thickness.

### FIELD OF THE INVENTION

The present invention relates to an aluminium alloy brazing sheet. In particular, the invention further relates to a method of making aluminium alloy brazing sheet.

### BACKGROUND OF THE INVENTION

Aluminium alloy brazing sheets usually comprise of a core sheet of an aluminium alloy core material and a clad layer of an aluminium alloys having silicon, zinc, manganese or magnesium as the main alloying elements on at least one side of the core sheet. Since aluminum alloys are light-weight and have high thermal conductivity, brazed aluminium heat exchangers such as radiators, condensers, evaporators etc. are commonly used in automotive engine cooling or air conditioning systems as well as in industrial cooling systems.

In making of aluminium alloy brazing sheets, rolling ingot of core alloy is cast by the direct chill casting process and then scalped to prepare a flat sheet. Cladding alloy sheets, also known as liner alloy sheets, are prepared by hot rolling to desired thickness and cut to the length of the core alloy ingot. The surface of the cladding and core alloy sheets are prepared for bonding by degreasing and cleaning. A clad package is then prepared by sandwiching the core alloy sheet between cladding alloy sheets. The cladding alloy sheets on both the sides may be of different alloy composition and thicknesses.

The clad package is then heated in a furnace to a temperature of 450-550° C. and rolled together in a hot mill at high pressures and in the temperature range of 400-500° C. to produce the cladded reroll coil. Hot rolling is carried out to create a metallurgical bond between the core and the liner alloy by diffusion. The reroll is then cold rolled to the final thickness. Intermediate or temper annealing may be optionally being employed during cold rolling. Optionally a final annealing treatment may be given to the cladded sheet to produce the final product in soft temper.

This process has several drawbacks. Improper bonding between the core and the liner alloy leads to formation of blisters during annealing process leading to very poor product recovery. The scrap generated during the hot cladding process is a mixture of the core and the liner alloys and not easily recyclable. The process of preparing the clad packaged involving cleaning and welding is very time consuming and adds to the product cost as well as leads to product quality issues. Also, some alloys form thick oxide layers during pre-heating and adversely affect the diffusion bonding process.

To overcome the drawback of prior art documents, alternate methods have been suggested in, WO2003035305Al. WO'305Al describes a process of making composite ingots by casting of two or more different alloys simultaneously and thereby eliminating the need for hot roll bonding. This process leads to good metallurgical bonding between the liner and core. This process, however, requires multiple furnaces during the casting process to prepare the cladded rolling ingot. In practice, this process can be employed for producing cladded sheet of only two alloys and takes away the flexibility of producing three or more clad packages as desired in the industry. Additionally, this process also leads to generation of high amount of mixed alloy scrap that is difficult to recycle.

US20040045643Al recites a method of making a composite aluminium brazing sheet, which method comprises: providing a core sheet of a first Al alloy and a cladding sheet of a second Al alloy, wherein a) the composition of the first Al alloy is different from the composition of the second Al alloy, b) the thickness of the core sheet is greater than the thickness of the cladding sheet, and c) the hardness of the core sheet is different than the hardness of the cladding sheet, cleaning facing surfaces of the core sheet and of the cladding sheet; and cold rolling the core sheet with the cladding sheet so as to roll bond them to make a composite aluminium sheet.

### OBJECT OF THE INVENTION

To address the drawback of prior art documents, the present invention provides a method of making aluminium brazing sheets based on an alternate cold roll bonding.

A primary objective of the invention is to provide method for making aluminium brazing sheet having good metallurgical bond, good bond strength, high static strength, enhanced brazability, significantly lesser mixed alloy scrap generation.

Another objective of this invention is to provide a method for making aluminum brazing sheet having uniform clad layer thickness which is extremely beneficial during subsequent processing.

Yet another objective of the invention is to provide aluminium brazing sheet where the size of the primary silicon particles in the clad sheet is observed to be finer compared to the conventional process.

### SUMMARY OF THE INVENTION

The present invention relates to a process of making an aluminium alloy brazing sheet. The process comprises the steps of—
performing a primary cold rolling of a laminate structure comprising a core sheet of first aluminium alloy and a cladding sheet on at least one side of the core sheet with a second aluminium alloy, in a rolling mill to obtain a primary roll bonded laminate structure;
performing at least one secondary cold rolling of the primary roll bonded laminate structure in the rolling mill to obtain the aluminium alloy brazing sheet;
   wherein the ratio (D/T) of the roll diameter (D) of the rolling mill in step a. to the thickness (T) of primary roll bonded laminate structure is in a range of 30 to 500, and the percentage of thickness reduction carried out during step a. is 40-70%.

The present invention relates to a aluminium alloy brazing sheet comprising:
a. a core sheet of first aluminium alloy; and
b. a cladding sheet on at least one side of the core sheet with a second aluminium alloy;
   wherein the clad layer of brazing sheet has Silicon particles greater than 400 particles/sqmm/% Si content.

### BRIEF DESCRIPTION OF THE DRAWINGS

FIG. 1A: Schematic diagram of the roll bonding line used for Experiment II. The offline cleaning line for pretreatment of the coils before bonding

FIG. 1B: The bonding mill with 3 uncoiler and inline cleaning section for roll bonding in a 4 high cold mill.

FIG. 2. Various surface preparation techniques and patterns explored during lab scale cold cladding processes for both the core and liner material.

FIG. 3. Custom designed fixture to facilitate uniform surface preparation of sheets of any thickness at lab scale.

FIG. 4. Electron microscope image of good metallurgical bond established between the core and liner.

FIG. 5. Image of the undulations observed when the D/T ratio is high.

FIG. 6. Image free of undulations when D/T ratio is low.

FIG. 7. Electron microscope image shows the fracture surface after tensile testing. It can be observed that the fracture surface is continuous across the interface and no delamination is observed.

FIG. 8. Electron microscope image of brazing sheet after bending operation and no delamination is observed between the core and liner indicating a strong bond formation.

FIG. 9. Optical image showing evidence of incipient melting of fine, primary silicon particles at 570° C.

FIG. 10. Size distribution of the Si particles in the inventive sample wherein total no. of particles is more than 400 and comparative sample where the total no. of particles is less than 400.

FIG. 11 (a). Sample achieving uniform brazing when incipient temperature of Si particles is 570° C.

FIG. 11 (b). micrographs at the corresponding temperatures showing the melting around the Si particles.

### BRIEF DESCRIPTION OF THE INVENTION

In describing and claiming the invention, the following terminology will be used in accordance with the definitions set forth below. Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, the preferred methods and materials are described herein. As used herein, each of the following terms has the meaning associated with it in this section. Specific and preferred values listed below for individual process parameters, substituents, and ranges are for illustration only; they do not exclude other defined values or other values failing within the preferred defined ranges.

As used herein, the singular forms “a,” “an,” and “the” include plural reference unless the context clearly dictates otherwise.

The terms “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

As used herein, the terms “comprising” “including,” “having,” “containing,” “involving,” and the like are to be understood to be open-ended, i.e. to mean including but not limited to.

As used herein, the term “brazing sheet” refers to rolled aluminum alloy products manufactured using combination of alloys are used for manufacturing of heat exchangers by brazing in a furnace.

In the context of the invention, the term “roll diameter” (D) refers the diameter of the work roll used for cold cladding operation.

In the context of the invention, the term “percentage reduction” refers to the percentage of thickness reduction carried out during a particular rolling pass.

In the context of the invention, the term “hardness” refers to the resistance to deformation of the alloy at a particular load.

In the context of the invention, the term “roll bonding” refers to the process of bonding different aluminum alloys by rolling process.

In the context of the invention, the term “cold rolling” refers to rolling process carried out at room temperature.

In the context of the invention, the term “annealing” refers to the process of heating the aluminum alloy sheet or coil to a temperature above the ambient temperature to reduce its hardness and carry out microstructural changes in the alloy.

In the context of the invention, the term “surface roughness” refers to roughness variations in the surface as measured by either a profilometer or confocal microscopy.

### DETAILED DESCRIPTION OF THE INVENTION

In an embodiment, the present invention discloses a process for making aluminium brazing sheets comprises of, a) providing a core of first aluminium alloy; b) cladding said core, on one or two sides, with a second aluminium alloy, forming a laminate structure; c) performing a primary cold rolling of said laminate structure so as to roll bond core and cladding alloy of said laminate structure; and d) performing at least one secondary cold rolling step of roll bonded laminate structure to obtain aluminium brazing sheet of desired thickness.

An aspect, the invention provides for a method of making an aluminium brazing sheet. In the process the clad alloy sheet and core alloy sheet to be bonded are produced by either direct chill casting or continuous casting. The sheets to be bonded are hot and cold rolled to the desired thickness. The mating surface of the sheets to be bonded are chemically cleaned and mechanically abraded to increase the surface roughness. The core alloy sheet and cladding alloy sheets may be optionally annealed to control the hardness of the alloy. Coils of core sheet and cladding are sandwiched together and cold rolled to perform the roll bonding. The roll bonded composite sheet is further cold rolled to the desired final thickness. Thickness of the different strips are in the same ratio as desired in the final product. Final anneal may optionally be carried out to impart the desired final mechanical properties to the sheet.

In an embodiment, the process comprises the steps of—
a. performing a primary cold rolling of a laminate structure comprising a core sheet of first aluminium alloy and a cladding sheet on at least one side of the core sheet with a second aluminium alloy, in a rolling mill to obtain a primary roll bonded laminate structure;
b. performing at least one secondary cold rolling of the primary roll bonded laminate structure in the rolling mill to obtain the aluminium alloy brazing sheet; wherein the ratio of the roll diameter (D) of the rolling mill in step a. to the thickness (T) of primary roll bonded laminate structure (D/T) is in a range of 30 to 500, and the percentage of thickness reduction carried out during step a. is 40-70%.

The primary rolling is performed with rolling speed in a range of 2 to 600 meters per minute (mpm).

The primary roll bonded laminate structure exiting the rolling mill has a temperature of 50-1 50° C.

The core sheet and the cladding sheet have their respective hardness (H_{core}/H_{cladding}) ratio in the range of 0.8 to 1.2.

The core sheet and the cladding sheet have their respective thickness in a ratio in the range of 5.0 to 20.

The process additionally comprises a step of annealing the core sheet and the cladding sheet before primary cold rolling in step a.

The process additionally comprises a step of annealing the aluminium alloy brazing sheet after step b.

The annealing step is carried out at a temperature of 180-450° C. for 1-6 hours.

Preferably, the core sheet and the cladding sheet are surface treated before the primary cold rolling. The surface treatment is selected from chemical cleaning and mechanical abrasion. The chemical cleaning is carried out with an inorganic acid selected from HCl, H2SO4, HNO3, or an alkali selected from NaOH or KOH. The mechanical abrasion is carried out with emery paper, steel brushes of confirmations selected from straight wire, twisted wire, and criss-cross wire.

The core sheet and cladding sheet have surface roughness, Ra (roughness average) of above 0.50 microns.

The primary roll bonded laminate structure has width in a range of 300-1500 mm.

The primary rolling step a. is carried out in presence or absence of a lubricant.

The secondary rolling step b. is carried out in presence of a lubricant. The lubricant may be any lubricant known to a person skilled in art.

Another embodiment of the invention relates to an aluminium alloy brazing sheet comprising:
a. a core sheet of first aluminium alloy; and
b. a cladding sheet on at least one side of the core sheet with a second aluminium alloy;
wherein the clad layer of brazing sheet has Silicon particles greater than 400 particles/sqmm/% Si content.

The variation in thickness of clad layer of the brazing sheet is +0.4%.

In an embodiment, the incipient melting of the silicon particles starts at 570° C.

In an embodiment, the composition of the aluminium alloy in core sheet and the cladding sheet is decided based on the intended use of the composite sheet. As known to a person skilled in the art, to achieve desirable strength and formability in the brazing sheet, the core sheet aluminium alloy is critical. Preferably, for the core sheet, aluminium 3000 series alloy may be used. In an embodiment, for cladding sheets, aluminium 4045/4043/1050/7072 alloys may be used.

The mating surface of the strips to be bonded undergo surface treatment by chemical cleaning and mechanical abrasion to increase the surface roughness to ensure that the sheets are capable of roll bonding under cold rolling conditions. Chemical cleaning, which involves removing a surface of the underlying metal, is satisfactory. In an embodiment, chemical cleaning may be carried out using an inorganic acid such as HCl, H2SO4, HNO3 and/or alkali (NaOH, KOH) for a duration up to 2 minutes followed by water rinse. In an embodiment, mechanical abrasion may be carried out using emery paper, steel brushes of different configuration e.g. straight wire, twister wire, crisscross wires. Surface treated core and cladding sheets are then subjected to cold rolling. Preferably, surface roughness of said core and cladding alloy is above 10 microns.

The cold rolling step is preferably performed continuously on continuous strip or coil. The core sheet and the cladding sheet to be roll-bonded are combined to form a laminate structure to perform primary cold rolling. The width of laminate structure is in the range of 300-1500 mm During cold rolling, said laminate structure is passed through a rolling mill to undergo roll bonding.

Optionally, the laminate structure is subjected to an annealing process to improve the formability of core and cladding sheets.

The bonding strength during roll bonding is dependent on the surface roughness of the mating surfaces as well as the % reduction applied during the cold rolling step. The amount of % reduction needed for the bond formation is inversely proportional to the surface roughness of the mating surfaces. In an embodiment, the rolling speed may be between 2 to 600 mpm. The percentage reduction during roll bonding pass may vary between 40-70%.

Conventionally methods, such as the one disclosed in WO2002040210A2 teaches that, cold cladding for roll bonding is carried out at fairly low temperatures, preferably less than 50° C. Contrary to the knowledge available from WO'210, the inventors of the present invention found that, higher rolling speeds and higher exit temperatures were beneficial for improving the bond strength. In an embodiment, the temperature of laminate structure exiting the roll mill during primary cold rolling step is in the range of 50-150° C.

The roll bonded laminate structure is further subjected to a secondary cold rolling step to desirable thickness to achieve aluminium brazing sheet. The cold rolling process is optionally carried out in the presence of a lubricant. In an embodiment, said aluminium brazing sheet is subjected to an annealing at a temperature of 180-450° C. for duration of 1-6 hours to improve formability. The process, further comprises of, annealing the aluminium brazing sheet. The secondary cold rolling and annealing enhance the bond between the cladding sheet and the core sheet.

In an embodiment, the aluminium brazing sheet may be subjected to a secondary cold rolling step. The secondary cold rolling step is performed in the presence of lubricant.

It is generally believed that the hardness of the core should be higher than that of the clad layer to achieve successful roll bonding. The inventors of the present invention, after extensive research, found that, the higher clad hardness is desirable for successful roll bonding when the ratio (D/T) of work roll diameter (D) to thickness (T) of laminate structure is low. The relative strength of the clad and liner plays an important role in the amount of compressive and shear forces generated at the bonding interface. In an embodiment, the ratio of hardness of core alloy to cladding alloy is maintained in the range of 0.8 to 1.2.

The surprising aspect of this invention is the close dependence the success of roll bonding has on the ratio of thickness of the different strips of the clad package, the relative hardness of the different strips, surface roughness and the roll diameter (D). It was found that the high compressive stresses and material flow are desirable to ensure good bond strength. To achieve this for a given ratio of the layer thicknesses, the ratio (D/T) of the work roll diameter (D) to the total thickness (T) of the package and the ratio of hardness of the different strips are controlled within a narrow range by the inventors. The method of present invention provides aluminium brazing sheets having high uniformity of the clad layer thickness. Conventional route of hot cladding leads to non-uniform flow in the clad layer leading to variations in the clad layer thickness across the width and the length of the coil. The aluminium brazing sheets from method of present application has significantly more uniform clad layer thickness which is advantageous during subsequent processing. During brazing, uniform clad layer thickness leads to consistent brazing response. In an embodiment, the ratio of thickness of core to cladding alloy in the range of 5.0 to 20.0 and the ratio (D/T) of roll diameter (D) to thickness (T) of laminate structure is in the range of 30 to 500.

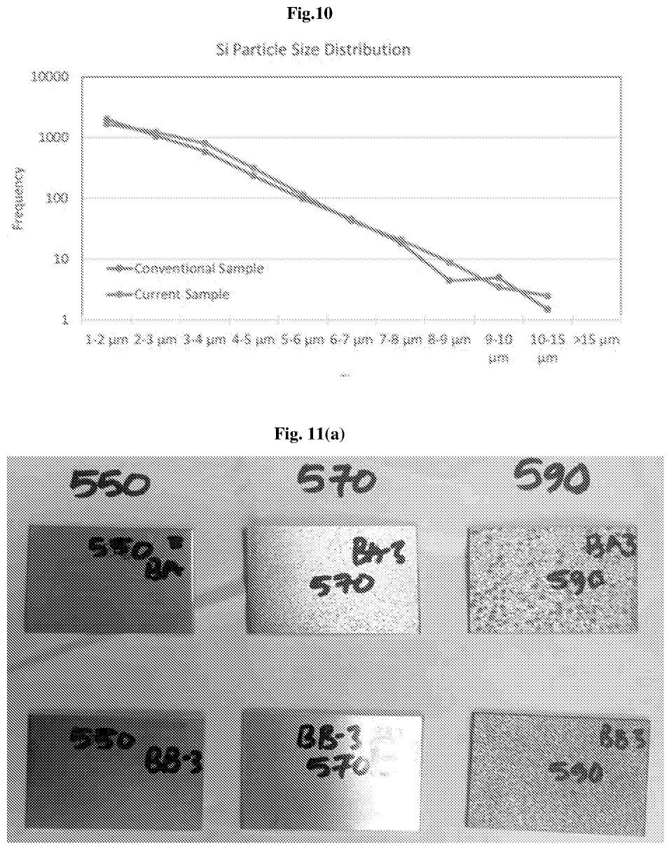

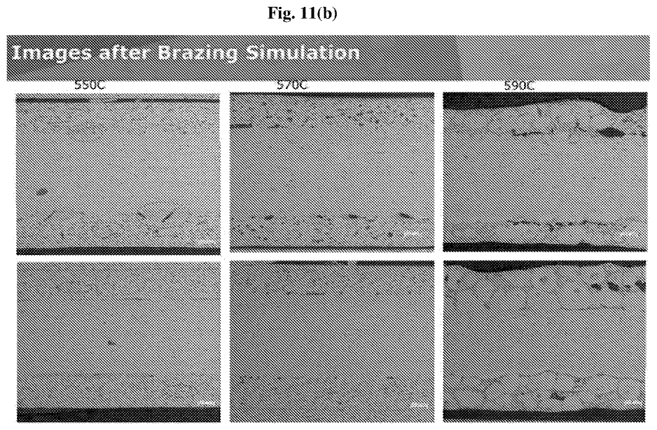

Another important feature of the method is that the size of the primary silicon particles in the clad sheet is observed to be finer. It is well known to those experienced in art that large silicon particles in the clad sheet adversely affect the brazing response. Fine silicon particles are therefore considered desirable for improving brazing response. Accordingly, the present inventors have also arrived at the number of Si fine particles in the brazing sheet as obtained by the process of the present invention using microscopy and image analysis which results in uniform brazing. This method of the study of particle size distribution is well known in prior art. A sample is taken and polished through the standard metallographic practice leading to a scratch free surface with a mirror finish. Intermetallic are revealed through mechanical polishing due to differential hardness with respect to the aluminium matrix. However, for better results, samples are etched in 0.5% HF acid for 10s. The images are captured at 350 to 500× magnification range suitable for capturing particles of interest (>1 μm) without compromising on the imaging area. The information extracted by this technique is normalized to be reported per sqmm (mm²). The particle size distribution is defined as particles/mm² of the combined image analysis area considered. To compare effect of process on particle size from the different cladding (hot/cold) routes, this was normalized for the % Si content in the liner material. It has been observed that the number of Si particles is more than 400 in a representative sq mm image area in a brazing sheet as per the present invention whereas it is lower in a conventional brazing sheet having the same amount of silicon. Finer silicon particles, due to higher surface area to volume ratio will melt faster and more uniformly and the liner will demonstrate complete brazability and better flow to ensure good bonding during the brazing operation. FIG. 10 is a graphical representation of the size distribution of the silicon particles as per the present invention and as per a conventional sample. It is seen that the conventional sample has less than 400 particles/sqmm/% Si content whereas the sample as per the present invention has more than 400 particles/sqmm/% Si. By the method claimed in present application, primary silicon particles break up into fine particles during hot and cold rolling. Brazing simulations show that incipient melting of these fine particles starts at temperature as low as 570° C. Different trials were done simulating the brazing conditions at different temperatures and microsections studied. Microstructural investigations of cladded samples after lab brazing simulations show that evidence of incipient melting at these fine particles at temperatures as low as 570° C. in the brazing sheet as per the present invention. However, the reported liquidus/incipient for a liner alloy is higher and is around 574° C. The lowering in the incipient temperature is possible because of the finer silicon particles as achieved in the process of the present invention, which, due to higher surface area to volume ratio will melt faster and more uniformly and the liner will demonstrate complete brazability and better flow to ensure good bonding during the brazing operation. The uniform brazing is reflected in FIG. 11.

D/T ratio controls the amount of shear strain induced in the laminate during primary rolling. It has been found that large roll diameters promote shear strains near the surface. Such strains are detrimental to cold cladding and therefore low values of D/T are preferable for high bond strength.

During the primary rolling step, formation of a metallurgical bond happens due to the extrusion of the liner material through the surface oxide of the core. In order to successfully achieve this, the liner material should be able to “flow” vertically through the core material. It is, therefore, necessary that sufficiently high compressive forces are available in the roll bite to promote the vertical flow of the liner material. For this reason, high amount of reduction during primary rolling step is needed.

Rolling at lower speeds and higher exit temperatures during primary rolling allows for diffusion of liner in core to happen, leading to stronger metallurgical bond.

The flow stresses of the liner and core should be comparable, and their ratio H is a critical process variable. Ideally the liner should have flow stress lower than the core allowing it to flow into the core. Since the flow is non-uniform across the thickness during the rolling process, it is desirable that the material flow of the liner, which is closer to the surface, should dictate the bonding. A very rigid core is also not desirable as it would increase the resistance to the flow of the liner into the core. Thus, the rolling load should lead to simultaneous deformation of both the core and the liner and therefore the ratio HcorefHcladding should be controlled. Annealing of the core and/or liner may be carried out prior to primary rolling to achieve the specified ratio.

As mentioned above, for successful bonding, the liner material should extrude through the oxide layer of the core and form a bond. To facilitate this mechanism, surface treatment is needed. Surface treatment (a) reduces the oxide layer thickness allowing for the penetration of the core by the liner material, (b) higher surface roughness introduces additional peaks and valleys for the extrusion process to take place and (c) higher roughness leads to higher friction between the core and liner, reducing the probability of slipping and increasing the propensity for bonding. All these mechanisms improve the bond strength.

Primary and secondary rolling operations lead to break up of the silicon particles in the liner leading to higher particle count, smaller Si particles, lower incipient melting temperature. This improves the fluidity of the liner during brazing leading to superior brazing performance.

Since the bonding of the core and liner is carried out during cold rolling (as compared to conventional process where this is during hot rolling), not much secondary rolling of the laminate is required. Thus the amount of mixed alloy scrap generated is much lesser compared to conventional hot cladding process where high amount of mixed alloy scrap Is generated during hot rolling and subsequent cold rolling operations.

Flow uniformity is also critical for ensuring a uniform clad layer thickness as demonstrated in the current work. During hot cladding, the flow behaviour of the liner and clad is very different due to several reasons, i.e. hot deformation behaviour of the different alloys, non-uniformity of the flow behaviour across the width and the higher initial thickness leading to higher variation in clad layer thickness. By tailoring the temper of the different alloys for the core and liner and controlling the rolling conditions, it is possible to design rolling practices that will allow greater control on the clad layer thickness consistency. This is a critical product attribute for the customer as the clad layer thickness, especially for cladded finstock, has direct impact on the brazing quality of the heat exchanger. Another product feature that can be controlled through the cold cladding is the primary silicon particle distribution. Finer Si particles are desirable in the liner, as they promote melting and fluidity of the clad layer during brazing. By controlling the amount of hot and cold rolling prior to cold cladding, it is possible to arrive at finer Si particle size distribution as shown in FIG. 18.

Another important feature of cold cladding is that the bonding step is significantly downstream compared to hot cladding. This significantly reduces the amount of mixed alloy scrap generation during the manufacturing process. As is well understood, recycling of mixed alloy process scrap poses significant challenges and reduction in the amount of such scrap generated is beneficial for the manufacturing plants. Results from the pilot scale trials show that up to 90% recoveries could be attained during cold cladding. Of course, further trials with wider width and higher speeds would help gain better understanding of the product recoveries. Initial results indicate operating cost for cold cladding could by up to 10% lower than that for hot cladding, considering better recoveries.

Having described our invention as related to the present embodiments, it is our intention that the invention not be limited by any of the details of the description, unless otherwise specified, but rather be construed broadly within its spirit and scope as set out in the description.

### INDUSTRIAL APPLICABILITY

According to the invention, an aluminum alloy brazing sheet which is thin but has excellent brazability and recyclability is obtained. Aluminum brazing sheet of present application is used in industrial heat exchangers and those used in automobile for its thermal conductivity, and the good bond strength.

### Examples

### [I] Example I

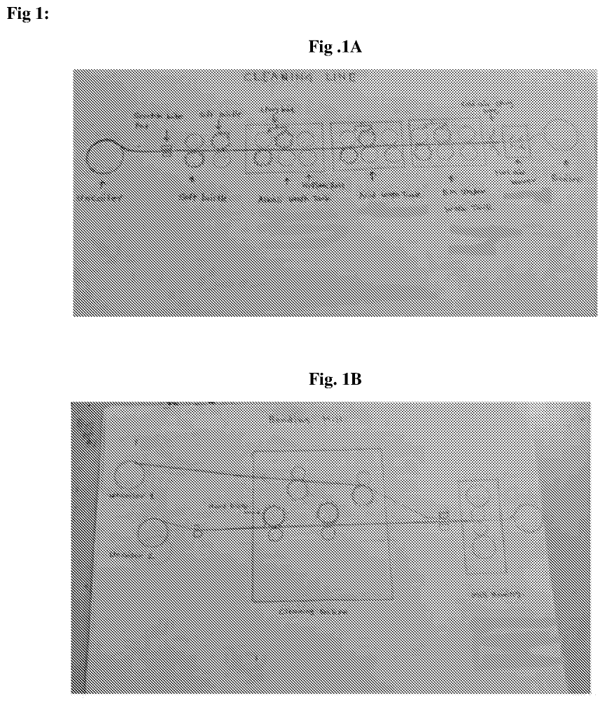

A two high, 200 T lab rolling mill shown in FIG. 1 was used for these trials. 300 mm diameter rolls were used for these trials at rolling speed between 3.7 to 15.0 mm/min No coolant was used during cold rolling and the exit temperature of the strip is dependent on the rolling speed. Higher rolling speeds of 15 mm/min lead to higher exit temperature up to 120° C. in this configuration. At lower speed of 3.7 mm/min, the exit temperature is in the range of 50-90° C. depending on the amount of cold reduction.

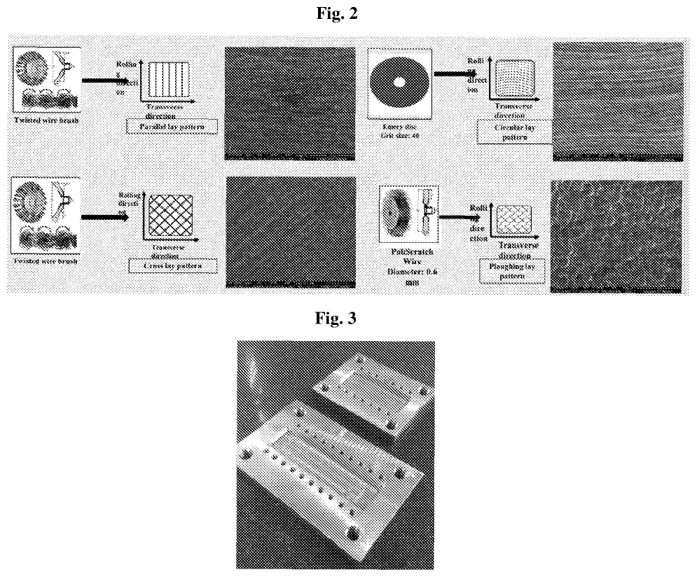

25 mm wide and 62.5 mm long samples were extracted from the sheets parallel to the rolling direction for cold cladding trials. Laminate thickness was varied between 4.0 and 7.0 mm leading to D/T ratio between 43 and 75. Several methods of surface preparation were explored as shown in FIG. 2. From these trials, a hybrid method of twisted wire brush-cross lay and Poliscratch is chosen for thin sheet and thick sheet respectively. A special fixture was designed for surface treatment in lab as shown in FIG. 3.

During cold cladding, reduction ratio varied between 30 to 70% during the bonding step. For this process, the initial package thickness was kept constant and different reduction ratio were achieved by varying the roll gap. Subsequently, additional rolling passes were given to achieve the final thickness of 1.0 mm for the cladded sheets. Several combinations of core and liner material were used to vary the core and clad hardness ratio between 0.61 and 1.22.

### [II] Experiment II

The schematic diagram of the process followed for Experiment II is shown in FIG. 1. The process flow comprises of a cleaning line which has a mechanical cleaning section using soft bristles and then a chemical cleaning section for degreasing, rinsing and drying. The cleaned coils are then taken to the bonding line where there faying interface is roughed using hard bristles and then cold bonded in a 4 high cold mill under heavy reduction. Heat treatments, if any, are carried out in off line annealing furnaces before or after the bonding pass. The bonding line can also be used to give additional rolling reductions as required to get to the final gauge.

Hot rolled 6.54 mm AA3003-F sheets and cold rolled 0.52 mm TAA1050-H14 strips were used as the core and liner material respectively in the initial processes. For subsequent processes, cold rolled 0.50 mm AA4045-H19 sheets were used as liner material. Chemical composition of material used for piloting trial is listed in Table 1.

### Chemical Composition of the Material Used for Experiment II

TABLE 1

| Alloy | Lot # | Si | Fe | Cu | Mn | Mg |
|---|---|---|---|---|---|---|
| AA4045 | Sample 1 | 9.98 | 0.52 | 0.029 | 0.031 | 0.01 |
| AA3003 | Sample 2 | 0.22 | 0.49 | 0.108 | 1.22 | 0.008 |
| AA1050 | Sample 3 | 0.15 | 0.28 | 0.03 | 0.02 | 0.02 |

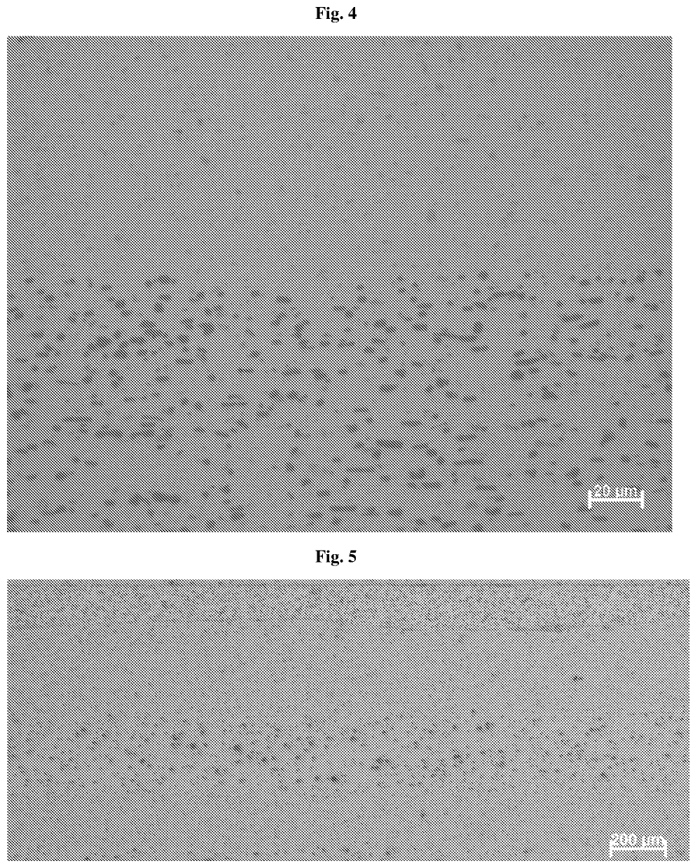

The width of the input coils was kept 300 mm to fully utilize the capabilities available at the pilot mill. On-line twisted wire brush was used to roughen the interface and the surface roughness was measured using confocal microscopy. Surface roughness of the interface was measured to be between 3.8 and 4.2 microns for the core and liner as shown in FIG. 4. The rolling speed was kept at 4 mpm and the exit temperature of the sheet was measured to be 80° C.

### Mechanical Properties

Mechanical properties of the as-rolled and annealed material used for cold cladding processes in Experiment I and II are listed in Table 2 below. To investigate the effect of hardness ratio on the cold cladding performance, additional strain hardening through cold rolling and subsequent annealing treatments were performed. The hardness values obtained through these treatments are shown in FIG. 5.

Mechanical properties of the alloys used for cold cladding in the as-rolled condition and annealed conditions. Proof strength is the stress required to achieve observable plastic deformation in the brazing sheet, ultimate strength is the maximum stress observed during standard tensile strength and the elongation is the total elongation observed in the sheet after fracture in tensile test.

TABLE 2

| | Proof | Ultimate | |
|---|---|---|---|
| | Strength | Strength | |
| | (MPa) | (MPa) | Elongation (%) |
| AA3003 - | 112 | 186 | 31% |
| Sample 2 As | | | |
| Rolled | | | |
| AA3003 - | 45 | 114 | 35% |
| 350° C./4 h | | | |
| AA1050 - | 124 | 154 | 19% |
| Sample 3 As | | | |
| Rolled | | | |
| AA1050 - | 40 | 72 | 46% |
| 350° C./4 h | | | |
| AA4045 - | 209 | 238 | 1% |
| Sample 1 As | | | |
| Rolled | | | |
| AA4045- | 67 | 125 | 26% |
| 250° C./3 h | | | |

### Characterization

Several methods were used to characterize and evaluate the cold bonded sheets. Metallographic examination of the longitudinal and transverse cross section was carried out under a Zeiss optical microscope to study the interfacial bonding, clad layer thickness and its variation and incipient melting after lab scale brazing simulations. Standard metallography techniques, i.e. sectioning, mounting, griding and polishing to 1 micron finish using diamond paste were employed. The polished specimen was etched in HF and then examined under a metallurgical microscope at appropriate magnification.

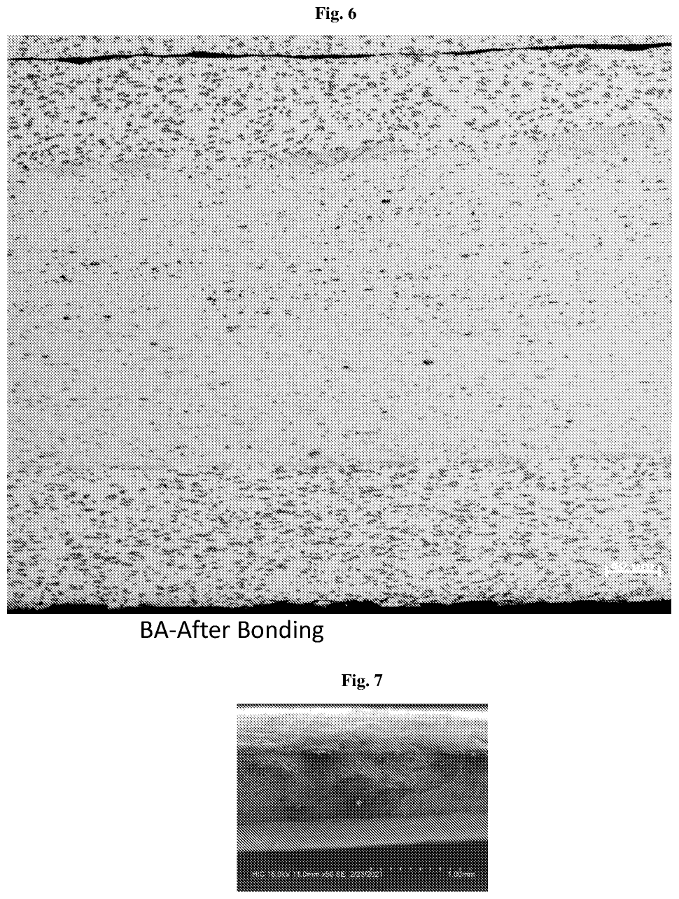

As can be seen in image m FIG. 4, a good metallurgical bond is established between the core and liner. The interface is observed to be integral and without any discontinuity. In FIG. 5, it is observed that some undulations are seen when the D/T ratio is high which are not observed in FIG. 6 when the D/T ratio is low.

Tensile tests were carried out using standard dog-bone test specimen as per ASTM E8 and bend tests were carried out to evaluate the delamination between the clad and liner layer.

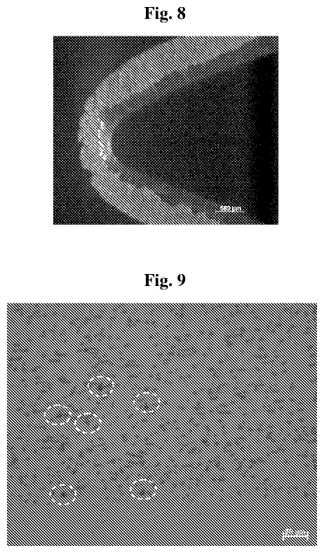

Electron microscope was used to characterize the fracture surface and mode of fracture. The image in FIG. 7 shows the fracture surface after tensile testing. It can be observed that the fracture surface is continuous across the interface and no delamination is observed. The image in FIG. 8 shows the brazing sheet after bending operation and no delamination is observed between the core and liner indicating a strong bond formation.

Lab scale brazing simulation was carried out by rapidly heating the cladded sheet to the brazing temperature between 550-620° C. followed by water quenching. Samples after brazing simulation were analyzed by visual inspection for blister formation and under optical microscope for evidence of incipient melting. FIG. 9 shows the optical image showing evidence of incipient melting of fine, primary silicon particles at 570° C. Trials were carried out in a commercial brazing furnace at the customer end to get feedback on the brazing performance during actual brazing operation. The results showed excellent brazability and formation of fillet joints exceeding the quality of those obtained from conventional brazing sheet.

1-17. (canceled)

18. A process of making an aluminium alloy brazing sheet, the process comprising the steps of—
a. performing a primary cold rolling of a laminate structure comprising a core sheet of first aluminium alloy and a cladding sheet on at least one side of the core sheet with a second aluminium alloy, in a rolling mill to obtain a primary roll bonded laminate structure;
b. performing at least one secondary cold rolling of the primary roll bonded laminate structure in the rolling mill to obtain the aluminium alloy brazing sheet;
wherein the ratio (D/T) of the roll diameter (D) of the rolling mill in step a. to the thickness (T) of primary roll bonded laminate structure is in a range of 30 to 500, and the percentage of thickness reduction carried out during step a. is 40-70% further wherein the core sheet and the cladding sheet have their respective hardness (H_{core}/H_{cladding}) in a ratio in the range of 0.8 to 1.2 and the primary roll bonded laminate structure exiting the rolling mill has a temperature in a range of more than 50 up to 150° C.

19. The process as claimed in claim 18, wherein the primary rolling is performed with rolling speed in a range of 2 to 600 meters per minute (mpm).

20. The process as claimed in claim 18, wherein the core sheet and the cladding sheet have their respective thickness in a ratio in the range of 5 to 20.

21. The process as claimed in claim 18, additionally comprising a step of annealing the core sheet and the cladding sheet before primary cold rolling in step a.

22. The process as claimed in claim 21, wherein the annealing step is carried out at a temperature of 180-450° C. for 1-6 hours.

23. The process as claimed in claim 18, additionally comprising a step of annealing the aluminium alloy brazing sheet after step b.

24. The process as claimed in claim 23, wherein the annealing step is carried out at a temperature of 180-450° C. for 1-6 hours.

25. The process as claimed in claim 18, wherein the core sheet and the cladding sheet are surface treated before the primary cold rolling.

26. The process as claimed in claim 25, wherein the surface treatment is selected from chemical cleaning and mechanical abrasion.

27. The process as claimed in claim 26, wherein the chemical cleaning is carried out with an inorganic acid selected from HCl, H2SO4, HNO3, or an alkali selected from NaOH or KOH.

28. The process as claimed in claim 26, wherein the mechanical abrasion is carried out with emery paper, steel brushes of confirmations selected from straight wire, twisted wire, and criss-cross wire.

29. The process as claimed in claim 25, wherein the core sheet and cladding sheet have surface roughness, Ra (Roughness Average) of above 0.5 microns.

30. The process as claimed in claim 18, wherein the primary roll bonded laminate structure has width in a range of 300-1500 mm.

31. An aluminium alloy brazing sheet comprising:
a. a core sheet of first aluminium alloy; and
b. a cladding sheet on at least one side of the core sheet with a second aluminium alloy;
wherein the sheet has Silicon particles greater than 400 particles/sqmm/% Si content.

32. The brazing sheet as claimed in claim 31, wherein variation in thickness of the cladded layer in the laminate is ±0.4%.

33. The brazing sheet as claimed in claim 31, wherein the incipient melting of the silicon particles starts at 570° C.
